(19) United States
(12) Patent Application Publication
(10) Pub. No.: US 2005/0077440 A1
(43) Pub. Date: Apr. 14, 2005

(54) Electronic device support

(76) Inventors: Walter T. Kochanski, Kendallville, IN (US); Frank Roe, Wolcottville, IN (US); Randall L. Bixler, LaGrange, IN (US)

Correspondence Address: Todd T. Taylor;TAYLOR & AUST, P.C., 142 S. Main St., P.O. Box 560, Avilla, IN, 46710, US

(21) Appl. No.: 10/685,373

(22) Filed: Oct. 14, 2003

(51) Int. Cl. F16M 11/00; F16M 13/00

(52) U.S. Cl. 248/125.7

(57) ABSTRACT

An electronic device support having an elongate member and a support arm including a band and at least one cantilever arm extending from the band, the band positioned around the elongate member, the band being slidable and rotatable relative to the elongate member.

### BACKGROUND OF THE INVENTION

1. Field of the Invention

The present invention relates to an electronic device support apparatus, and, more particularly, to electronic device supports that are used in conjunction with a worksurface such as a modular desk.

2. Description of the Related Art

Electronic devices with manual entry of data or control, such as desktop and laptop computers, notebook computers, calculators, palm pilots, dictation machines and the like generally include some form of keyboard. The ergonomic principles of using a keyboard generally require that, when used with a desk, the keyboard be mounted on a different surface than the desktop to allow for the comfortable positioning of the keyboard operator's hands while operating the keyboard. A worksurface such as a desk generally has a fixed height which will not be a comfortable keyboard height for most people. In addition to being adjustable for ergonomic reasons, it may be convenient for the keyboard to be supported by another surface to allow an unencumbered worksurface for other purposes.

One type of electronic device or keyboard platform can be mounted to the underside of a worksurface. This type of keyboard platform typically has mounting brackets, articulating apparatus which may allow translation and/or rotation of the platform, clamping mechanisms to lock the articulating apparatus in an appropriate position and the platform attached to the articulating apparatus. When not in use these platforms can typically be slid and/or rotated under the desk.

One of the problems associated with this type of keyboard platform is the amount of time, effort and skill required to mount the keyboard platform. Keyboard platforms of this type are usually provided with a template which must be positioned under the worksurface to identify the correct location of a multitude of drill holes for the platform. Holes must then be drilled in the desktop from the underside without breaking through the desktop. The template is generally made of a large piece of paper which has been folded several times for shipping purposes and is therefore not particularly easy to position on the underside of a worsurface and, at the same time, maintain the correct relative positions of the drill holes. Misdrilled holes must be redrilled with the further risk of breaking through the worksurface. After mounting, clamping mechanisms hold the platform in place and must be loosened in order to correctly position the platform for keyboard use. The keyboard and platform are held in place by hand when positioning, and another hand must actuate the clamping mechanisms, which may be awkward. Actuating the clamping mechanisms generally apply torque to the platform which can cause the platform to move from the intended position. There may also be separate clamping mechanisms for linear and rotation adjustments which may further require an iterative adjustment procedure. These platforms are not easily portable, requiring dismounting and mounting if moved to another worksurface. As a minimum, a platform of this type will require at least one screwdriver, drill bits and a drill to install, and may require other tools such as wrenches to complete the installation.

The problems associated with mounting keyboard platforms are exaggerated in a modular furniture environment. Modular furnitures, by their design nature, are meant to be easily configurable to accommodate a changing work environment. Modem modular furniture can be assembled with a minimum or complete absence of tools. Mounting a keyboard platform, in the manner described above, to a modular furniture worksurface makes the worksurface less configurable and also goes against the basic design objectives of the modular office furniture.

Another type of electronic device or keyboard platform is a stand-alone platform. These stand-alone platforms may be supported on a frame with locking wheels to facilitate transportability and may also include other features such as wrist rests. A stand-alone platform typically can be rolled or carried to another workstation, if needed, without disassembly.

While these stand-alone platforms do not require mounting to the desk surface, and the associated problems therewith, they take up additional floorspace, can be awkward to work around, are relatively expensive and may not be easily positionable with respect to the computer tower.

What is needed in the art is an electronic device or keyboard support that is adjustable for keyboard operator's comfort, easily positioned, is easily moved out of the way when not in use, can easily be moved to another workstation and accomplishes such features with a simple and cost effective design.

### SUMMARY OF THE INVENTION

The present invention provides an electronic device support that is adjustable for operator's comfort, is easily positioned and locked in place, is easily moved out of the way when not in use, can easily be moved to another workstation and accomplishes such features with a simple and cost effective design.

The invention comprises, in one form thereof, an elongate member and a support arm including a band and at least one cantilever arm extending from the band, the band positioned around the elongate member, the band being slidable and rotatable relative to the elongate member.

An advantage of the present invention is the electronic device support is adjustable for keyboard operator's comfort.

Another advantage is the electronic device support of the present invention is not required to be mounted to the worksurface.

Yet another advantage is the electronic device support of the present invention can be positioned and locked in place with a single motion.

A further advantage is the electronic device support of the present invention is easily moved out of the way when not in use.

A yet further advantage is the electronic device support of the present invention can be easily removed from one workstation and placed in another workstation.

An even yet further advantage is the electronic device support of the present invention can be positioned proximate to a worksurface without using tools.

An even yet further advantage is the electronic device support of the present invention is a simple cost effective design.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of the present invention with a slidable platform mount and an electronic device or keyboard thereon and positioned on the underside of a worksurface;

FIG. 2 is a perspective, partially fragmentary view of the embodiment of FIG. 1 of the present invention showing a rotational characteristic of the carriage and a post spring;

FIG. 3 is a sectional view taken along section line 3-3 in FIG. 2 showing carriage spring detail;

FIG. 4 is a perspective view of an embodiment of the present invention with a slide track mounting configuration;

FIG. 5 is a sectional view taken along section line 5-5 in FIG. 4 showing slide details;

FIG. 6 is a perspective view of an embodiment of the support arm of the present invention with an extendable platform mount;

FIG. 7 is a side view of an embodiment of the electronic device support of the present invention, with the elongate member fixedly attached to the worksurface, and the extendable platform mount of FIG. 6;

FIG. 8 is a sectional view taken along section line 8-8 in FIG. 6 showing details of the extension slide;

FIG. 9 is a perspective view of a self supporting work station embodiment of the present invention;

FIG. 10 is another perspective view of the self supporting work station of the present invention shown;

FIG. 11 is a perspective view of an embodiment of the monitor platform of the self supporting work station of the present invention;

FIG. 12 is a side view of an embodiment of the flat screen monitor mount for the self supporting work station of the present invention; and

FIGS. 13A and 13B are perspective views of an embodiment of the storage area contained in the post of the self supporting work stations of the present invention.

FIGS. 14A and 14B are side views taken along section line 14-14 in FIG. 9 showing the self supporting work station base in a stationary upright (FIG. 14A) position and a tilted movable (FIG. 14B) position.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

Referring now to the drawings, and more particularly to FIG. 1, there is shown an electronic device or keyboard support 10 which generally includes elongate member 12, support arm 14 and platform mount 16. Keyboard support 10 is shown positioned under worksurface 18 with support arm 14 rotated from underneath worksurface 18 and with electronic device 20 positioned on platform mount 16. Electronic device 20 is shown as a keyboard but can alternatively be a laptop or notebook computer, calculator, dictation machine, palm pilot and/or other electronic devices requiring manual manipulation.

Elongate member 12 includes male member 24 partially inserted into female member 22. Longitudinal first end 26 of female member 22 engages worksurface 18 and longitudinal second end 28 of male member 24 engages floor surface 30. First end 26 and second end 28 may be made of a variety of materials such as plastic, wood, metal or rubber to facilitate a non-slipping engagement with worksurface 18 and floor surface 30, respectively. The wide choice of materials for construction of first end 26 and second end 28 can therefore accommodate a wide range of materials found in worksurface 18 and floor surface 30, respectively, which may be encountered in use. To further facilitate a non-slipping engagement between elongate member 12 and worksurface 18 and floor surface 30, first end 26 and second end 28 may also have surface contouring such as serrations, knurling, rings, blocking, pyramids and the like.

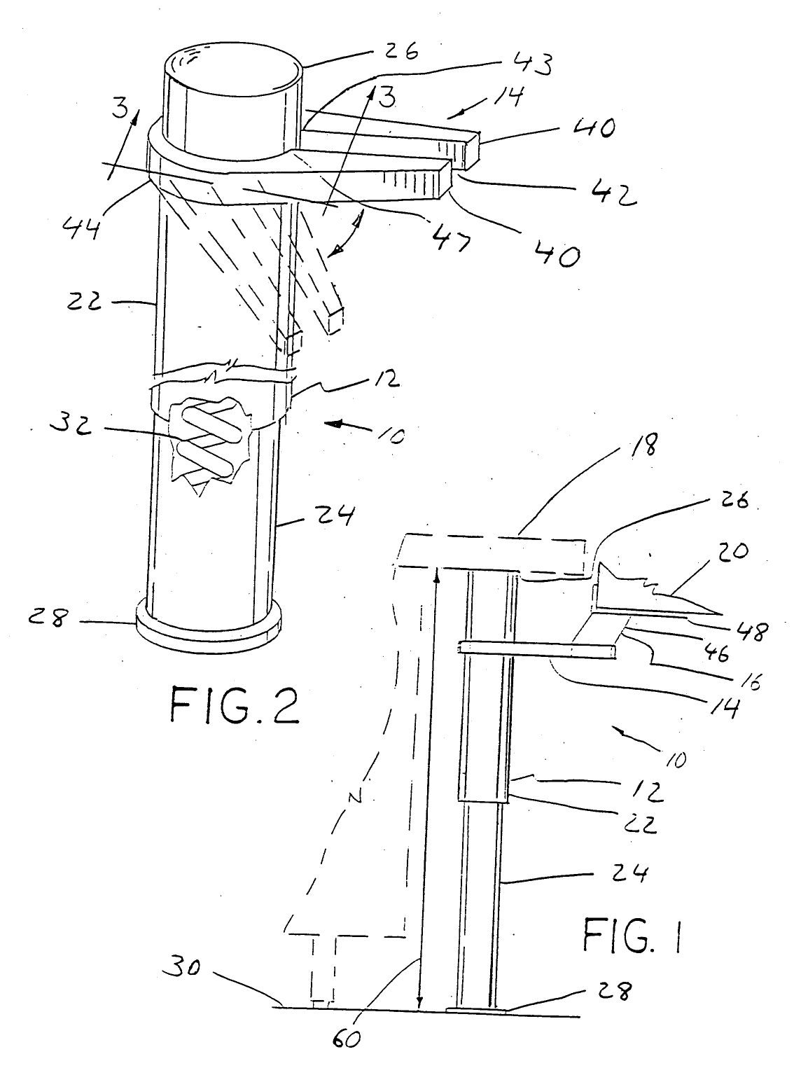

In an uncompressed state, elongate member 12 generally has an overall height greater than distance 60 between floor surface 30 and worksurface 18. Biasing element 32 (FIG. 2) is internal to elongate member 12 and engages female member 22 at one end of biasing element 32 and engages male member 24 at the other end of biasing element 32. Biasing element 32 is shown in FIG. 2 as a coil spring but can also be other spring types such as a leaf or spiral spring, or other biasing elements such as a compressible fluid filled container or a rubber or other resilient material elements. Biasing element 32 allows elongate member 12 to be compressed sufficiently to be positioned vertically between floor surface 30 and worksurface 18, and at the same time, provide compressive force to facilitate a non-slipping engagement between elongate member 12 and worksurface 18 and floor surface 30 sufficient to maintain the vertical positioning of elongate member 12 when support arm 14 or platform mount 16 are loaded with a static loading of a keyboard, a dynamic loading of a keyboard operator's keystrokes and a dynamic loading of the partial support of an operator's hands, wrists and arms.

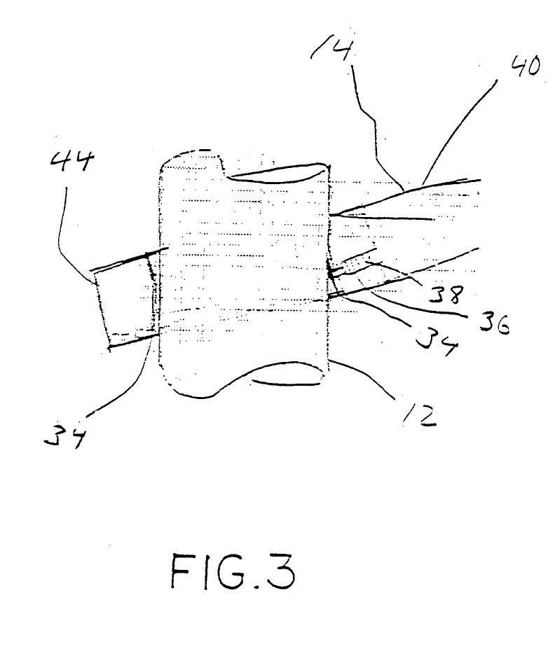

Support arm 14 includes at least one cantilever arm 40, with slot 42 therebetween, and attached to opening 45 at circumferential first end 43 and circumferential second end 47 in band 44, and bushing 34 interposed between elongate member 12 and band 44 and also between elongate member 12 and cantilever arms 40. Bushing 34 may be of rubber or other suitable material. Within at least one cantilever arm 40 (FIG. 3) there is spring detent 36 with support arm biasing element 38 therein, which can be a spring. Biasing element 32 is shown in FIG. 3 as a coil spring but can also be other spring types such as a leaf or spiral spring, or other biasing elements such as a compressible fluid filled container or a rubber or other resilient material elements. Bushing 34 allows support arm 14 to be tilted from an approximately orthogonal relationship with elongate member 12. This tilting action releases some of the frictional holding force being applied between elongate member 12 and bushing 34 by support arm biasing element 38 and thereby allows support arm 14 to be translated along a longitudinal axis of elongate member 12 and/or support arm 14 can be rotated about a longitudinal axis of elongate member 12.

Platform mount 16 includes slide 46 and electronic device or keyboard platform 48. Platform mount 16 may omit slide 46, and in this embodiment, electronic device platform 48 can be used without slide 46 and can be fixedly attached to a distal end of support arm 14 of the embodiments shown in FIGS. 1, 2 and 4 using suitable fastening elements such as screws, nuts and bolts, rivets, welds and the like. Alternatively, platform mount 16 can be slidably attached to support arm 14 by slidably connecting slide 46 in slot 42 and to cantilever arms 40. Platform mount 16 gives an additional degree of adjustment to keyboard support 10, i.e. an additional translational adjustment approximately orthogonal to elongate member 12 longitudinal axis, and since keyboard 20 is ultimately positioned on platform mount 16, an additional degree of adjustment to keyboard 20.

Keyboard 20 may also be mounted directly to support arm 14 through the use of suitable fastening elements.

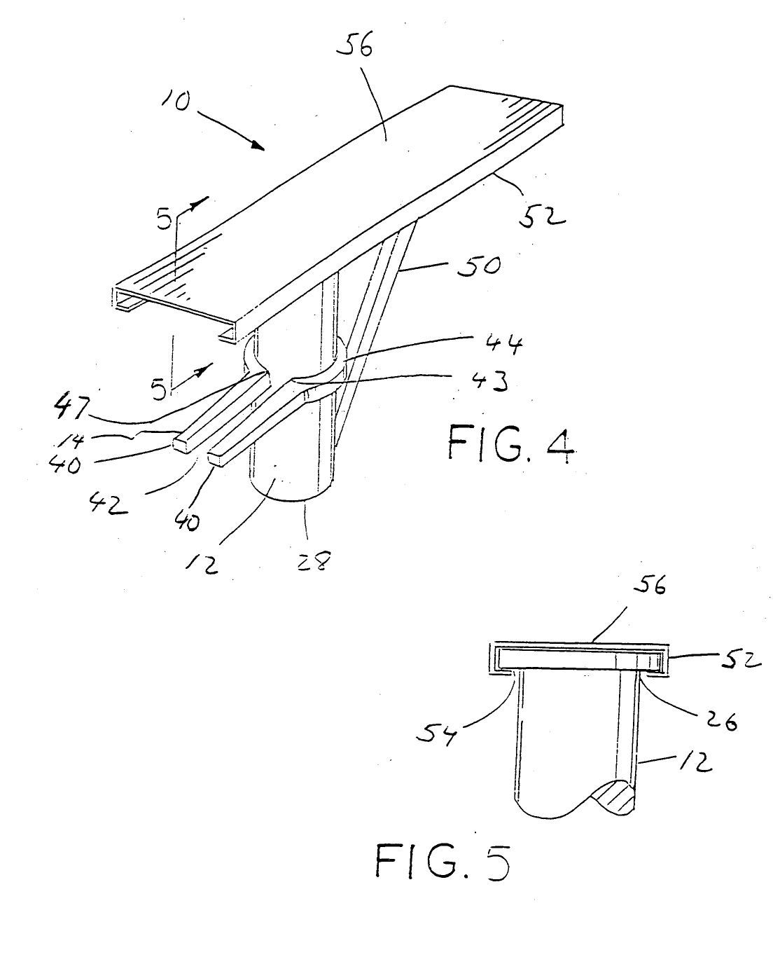

In an alternative embodiment (FIGS. 4 and 5) keyboard support 10 includes elongate member 12, support arm 14, brace 50 and slide track 52. Unlike the embodiment of FIGS. 1 and 2, surface 56 of slide track 52 is fixedly attached to worksurface 18 with suitable fastening elements. Mounting and adjustment of support arm 14 to elongate member 12 is as previously discussed. Elongate member 12 includes, at a first longitudinal end, bearing 54 slidingly positioned proximate to slide track 52. Brace 50 provides support for elongate member 12 and is connected at one end to elongate member 12 and at the other end to bearing 54. Second longitudinal end 28 of elongate member 12 does not contact floor 30 in this embodiment.

In use, elongate member 12 of FIGS. 1 and 2 is compressed and positioned under worksurface 18. Keyboard 20 is placed on electronic device platform 48. As mentioned previously, keyboard platform 48 may be attached directly to support arm 14, or alternatively; if slide 46 is connected to support arm 14, to slide 46. Biasing element 32 maintains a firm engagement between longitudinal first end 26 and worksurface 18 and between longitudinal second end 28 and floor surface 30. Support arm 14 is adjusted longitudinally and rotationally for keyboard operator comfort, and if slide 46 is used, additional translational adjustment approximately orthogonal to elongate member 12 can be made. When not in use keyboard 20 can be rotated and translated under worksurface 18 if desired. Keyboard support 10 can easily be moved to another workstation (not shown) by dismounting keyboard 20, compressing elongate member 12 and repositioning keyboard support 10 at another workstation.

In the embodiment of FIGS. 4 and 5, surface 56 is attached to the underside of worksurface 18. As mentioned previously, keyboard platform 48 may be attached directly to support arm. 14, or alternatively, if slide 46 is connected to support arm 14, to slide 46. Support arm 14 is adjusted longitudinally along elongate member 12 and also along slide track 52, and rotationally about elongate member 12 for keyboard operator comfort, and if slide 46 is used, additional translational adjustment can be made approximately orthogonal to elongate member 12. When not in use keyboard 20 can be rotated and translated under worksurface 18 if desired. Keyboard support 10 can be moved to another workstation (not shown) by dismounting keyboard 20, unattaching slide track 52 and repositioning and attaching keyboard support 10 at another workstation.

In the embodiment of FIGS. 1-5, keyboard 20 may also be mounted directly to support arm 14 through the use of suitable fastening elements.

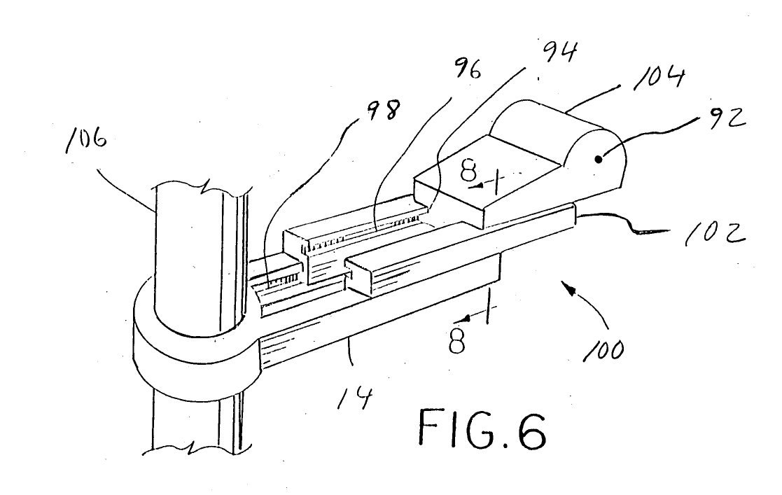

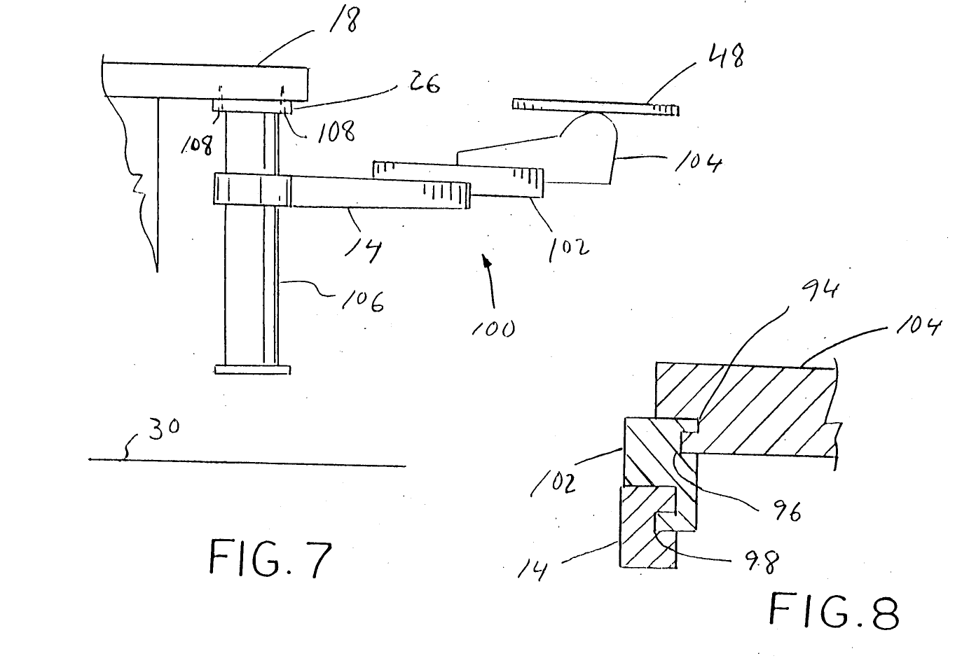

Referring to FIGS. 6-8, there is shown an extendable platform mount 100 including extension slide blocks 102, platform mount 104 and elongate member 106. Extension slide blocks 102 are slidingly engaged with support arm 14 by way of slide block slide grooves 96 in slide blocks 102 and corresponding support arm slide grooves 98 in support arm 14. Platform mount 104 is slidingly attached to slide blocks 102 by way of platform mount slide grooves 94 in both platform mount 104 and slide block slide grooves 96. Extendable platform mount 100 can have indexing capability in extension slide blocks 102 and/or platform mount 104. Elongate member 106 may be the same as that depicted in previously described embodiments or a part of a self supporting work station. In the embodiment of FIG. 7, elongate member 106 is shown fixedly attached to worksurface 18 by way of screws 108 or other suitable fastening elements. Platform mount 104 can have pivot attachment 92 to pivotally attach keyboard 20.

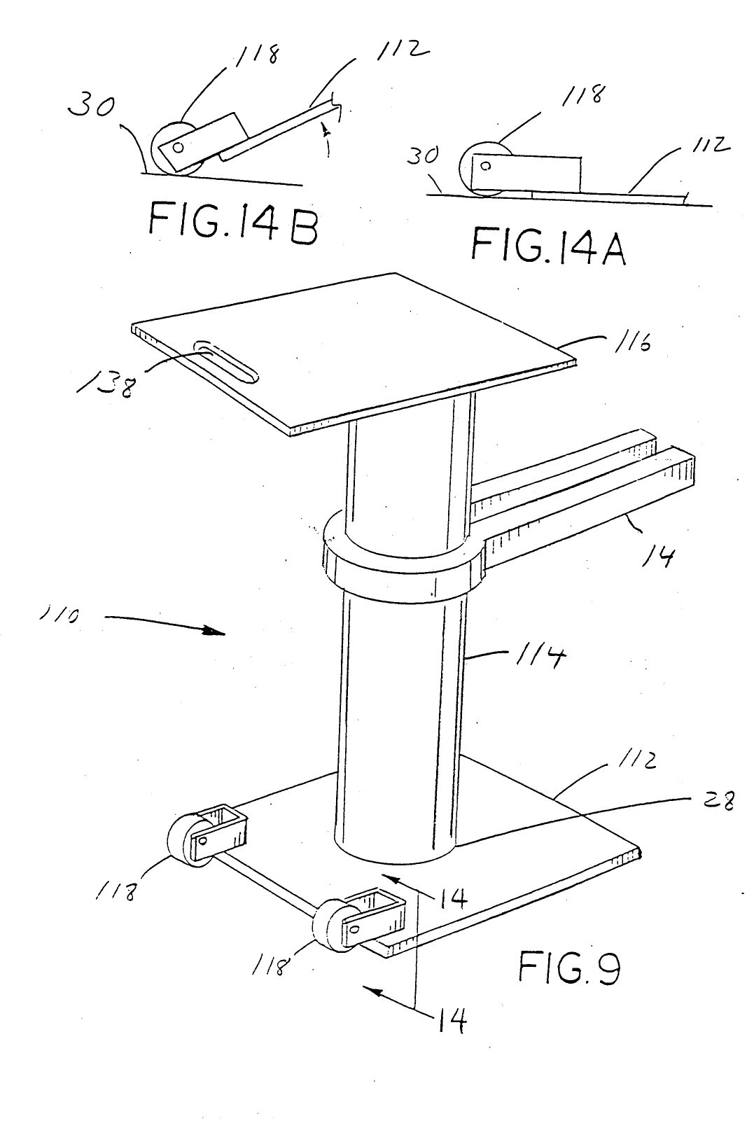

Self supporting work station 110 (FIGS. 9-12) including base 112, elongate member 114, support arm 14 and monitor mount 116. Base 112 has two wheels 118 on wheel side 136 of base 112 that are positioned to contact a floor when tilted. Tilting can be actuated by hand actuation of monitor mount 116 using handle recess 138. Base 112 is attached to elongate member 114 and is shaped and positioned to provide stability to work station 110. Computer 152 can be placed on base 112.

Elongate member 114 is hollow being attached to base 112 at one end and monitor mount 116 at another end. Elongate member 114 maybe telescopically adjustable in a vertical direction. Support arm 14 is slidingly disposed on elongate member 114. Also attached to elongate member 114 is chair 120 by way of chair support arm 122. Foot rests 126 are attached to either chair support arm 122 or elongate member 114. Chair 120 and foot rests 126 are ergonomically positioned. Chair 120, including seat 158 and backrest 160, has an adjustable support post 128, located on the floor side of seat 158, which coacts with chair support arm 122 to alter the position of chair 120.

At one end of support arm 14 a keyboard is slidingly mounted. At another end of support arm 14, proximate to elongate member 114 a utility distribution module 124 is attached. Utility distribution module 124 is in the form of a power strip which can also include communication terminals or receptacles.

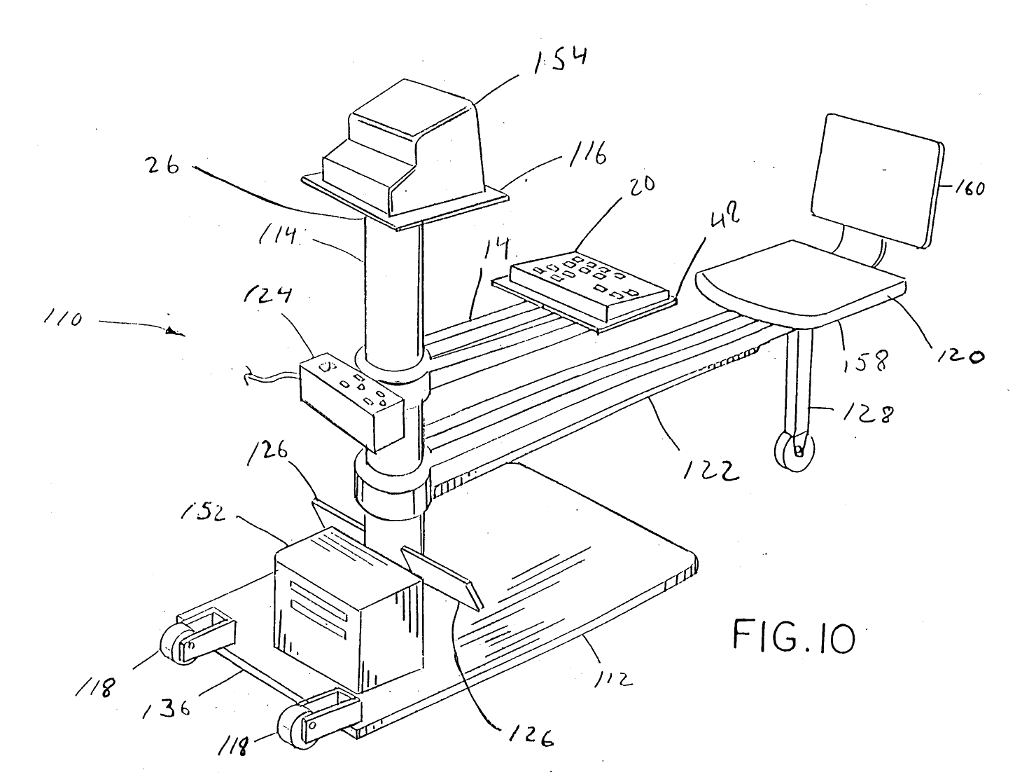

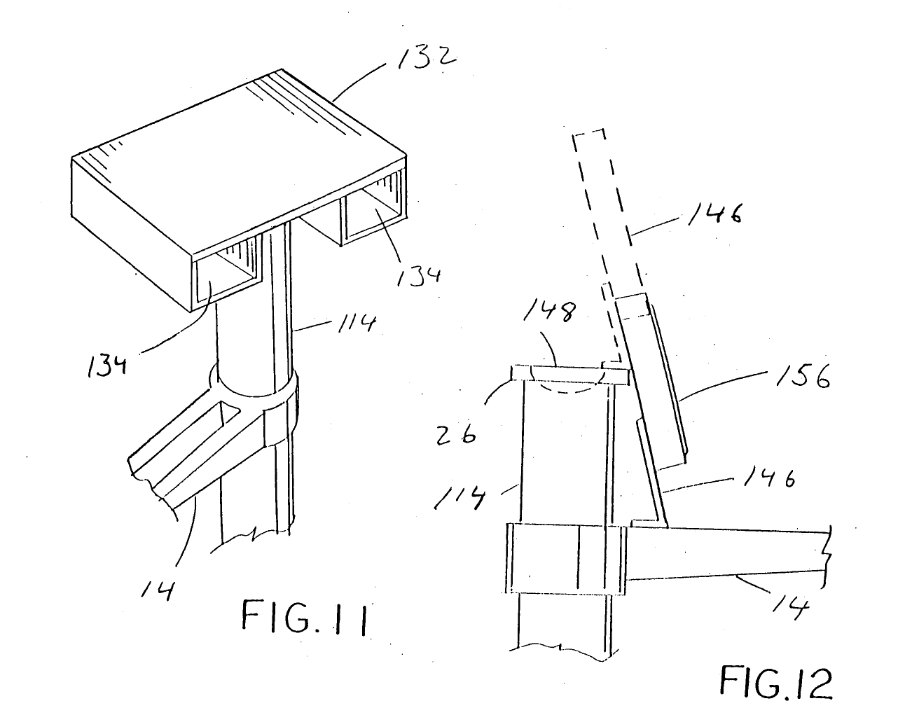

Referring to FIGS. 11 and 12, there is shown monitor platform 132. Monitor platform 132 interacts with and is attached to elongate member 114. Monitor platform 132 removably attaches to the end of elongate member 114, thereby providing a shelf for placing and mounting a computer monitor 154. Platform 132 includes storage areas 134 to place computer and office related items. An alternate flat panel monitor mount 146 is shown in FIG. 12 for a flat screen monitor 156. Elongate member 114 may have at first end 26 recess 148 for convenient storage of paperclips and other small office utility items.

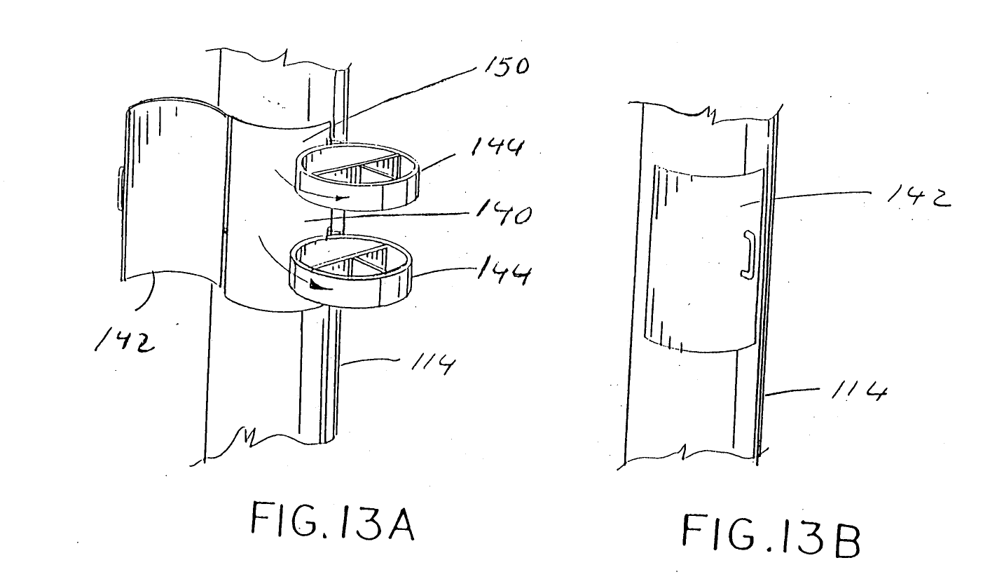

Storage area 140 (FIGS. 13A and 13B) in elongate member 114 including door 142 and pivoting storage units 144. Storage units 144 advantageously uses hollow portion 150 within elongate member 114. Alternatively, power and data connections and/or wiring may be routed through elongate member 114 and door 142 serves as an access to the routing.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An electronic device support, comprising:
an elongate member; and
a support arm including a band and a cantilever arm extending from said band, said band positioned around said elongate member, said band being slidable and rotatable relative to said elongate member.

2. The electronic device support of claim 1, wherein said elongate member is cylindrical.

3. The electronic device support of claim 1, wherein said elongate member includes a male member slidingly coupled with a female member in a longitudinal direction of said elongate member.

4. The electronic device support of claim 3, further including a biasing element interposed between said male member and said female member in said longitudinal direction.

5. The electronic device support of claim 4, wherein said biasing element is a spring.

6. The electronic device support of claim 1, further including a slot in said cantilever arm, said slot extending in a longitudinal direction of said cantilever arm.

7. The electronic device support of claim 1, further including an electronic device platform connected at a distal end of said cantilever arm.

8. The electronic device support of claim 1, further including an electronic device platform slidably connected to said cantilever arm.

9. The electronic device support of claim 1, further including a platform mount connected at a distal end of said cantilever arm.

10. The electronic device support of claim 1, further including a platform mount slidably connected to said cantilever arm.

11. The electronic device support of claim 1, said support arm further comprising:
a bushing between said elongate member and said band;
a spring detent located in at least one of said band and said cantilever arm and proximate to said bushing; and
a support arm biasing element located in said spring detent.

12. An electronic device support, comprising:
a slide track;
an elongate member slidably connected to said slide track; and
a support arm including a band and a cantilever arm extending from said band, said band positioned around said elongate member, said band being slidable and rotatable relative to said elongate member.

13. The electronic device of claim 12, wherein said elongate member is cylindrical.

14. The electronic device support of claim 12, further including a slot in said cantilever arm, said slot extending in a longitudinal direction of said cantilever arm.

15. The electronic device support of claim 12, further including an electronic device platform connected at a distal end of said cantilever arm.

16. The electronic device support of claim 12, further including an electronic device platform slidably connected to said cantilever arm.

17. The electronic device support of claim 12, further including a platform mount connected at a distal end of said cantilever arm.

18. The electronic device support of claim 12, further including a platform mount slidably connected to one said cantilever arm.

19. The electronic device support of claim 12, said support arm further comprising:
a bushing between said elongate member and said band;
a spring detent located in at least one of said band and said cantilever arm and proximate to said bushing; and
a support arm biasing element located in said spring detent.

20. An electronic device support for locating an electronic device proximate to a worksurface, said electronic device support comprising:
an elongate member with a longitudinal first end, said first end configured for attaching to the worksurface; and
a support arm including a band and a cantilever arm extending from said band, said band positioned around said elongate member, said band being slidable and rotatable relative to said elongate member.

21. The electronic device support of claim 20, wherein said elongate member is cylindrical.

22. The electronic device support of claim 20, further including a slot in said cantilever arm, said slot extending in a longitudinal direction of said cantilever arm.

23. The electronic device support of claim 20, further including an electronic device platform connected at a distal end of said cantilever arm.

24. The electronic device support of claim 20, further including an electronic device platform slidably connected to said cantilever arm.

25. The electronic device support of claim 20, further including a platform mount connected at a distal end of said cantilever arm.

26. The electronic device support of claim 20, further including a platform mount slidably connected to said cantilever arm.

27. The electronic device support of claim 20, said support arm further comprising:
a bushing between said elongate member and said band;
a spring detent located in at least one of said band and said cantilever arm and proximate to said bushing; and
a support arm biasing element located in said spring detent.

28. The electronic device support of claim 20, further including at least one extension slide block slidably connected to said support arm.

29. The electronic device support of claim 28, further including a platform mount slidably connected to said extension slide block.

30. An electronic device support for locating an electronic device with respect to a floor surface, said electronic device support comprising:
an elongate member having a longitudinal upper end and a longitudinal lower end;
a support arm including a band and a cantilever arm extending from said band, said band positioned around said elongate member, said band being slidable and rotatable relative to said elongate member
a monitor mount connected to said longitudinal first end; and
a base attached to said longitudinal second end, said base including a plurality of wheels rotatably connected to said base.

31. The electronic device support of claim 30, wherein said elongate member is cylindrical.

32. The electronic device support of claim 30, further including a slot in said cantilever arm, said slot extending in a longitudinal direction of said cantilever arm.

33. The electronic device support of claim 30, further including an electronic device platform connected at a distal end of said cantilever arm.

34. The electronic device support of claim 30, further including an electronic device platform slidably connected to said cantilever arm.

35. The electronic device support of claim 30, further including a platform mount connected at a distal end of said cantilever arm.

36. The electronic device support of claim 30, further including a platform mount slidably connected to said cantilever arm.

37. The electronic device support of claim 30, said support arm further comprising:
a bushing between said elongate member and said band;
a spring detent located in at least one of said band and said cantilever arm and proximate to said bushing; and
a support arm biasing element located in said spring detent.

38. The electronic device support of claim 30, further including an external utilities distribution module proximate to said support arm.

39. The electronic device support of claim 30, wherein said elongate member includes a hollow portion and a storage area positioned in said hollow portion.

40. The electronic device support of claim 39, further including a door hingedly attached to said elongate member, said door configured for accessing said storage area.

41. The electronic device support of claim 39, further including at least one storage unit pivotably attached to said elongate member, said storage unit in a first position located within said storage area and pivotable to a second position at least partially outside said storage area.

42. The electronic device support of claim 30, further including a handle recess in said monitor mount.

43. The electronic device support of claim 30, further including at least one storage area connected to said monitor mount.

44. The electronic device support of claim 30, further including a chair support arm adjustably connected at a first end to said elongate member, a chair connected to a second end of said chair support arm, said chair including a seat and a backrest, said seat having a seat side and an opposite side and an adjustable support post connected to said opposite side.

45. The electronic device support of claim 30, further including a flat panel monitor Mount adjustably connected to said support arm near said elongate member.

46. The electronic device support of claim 45, wherein said flat panel monitor mount is adjustably locatable to said longitudinal first end.

47. The electronic device support of claim 30, further including foot rests adjustably connected to said elongate member.
